(19) United States
(12) Patent Application Publication
(10) Pub. No.: US 2023/0246957 A1
(43) Pub. Date: Aug. 3, 2023

(54) TUNNELING EXTENSION HEADER FOR SEGMENT ROUTING

(71) Applicant: 3nets.io, Inc., Santa Clara, CA (US)

(72) Inventors: Corneliu-Ilie Calciu, Bucharest (RO); Gavril-Ioan Florian, Chitila (RO); Bin Liang, Plano, TX (US)

(21) Appl. No.: 17/860,457

(22) Filed: Jul. 8, 2022

Related U.S. Application Data
(60) Provisional application No. 63/306,380, filed on Feb. 3, 2022.

(51) Int. Cl. H04L 45/00; H04L 45/745; H04L 12/46

(52) U.S. Cl. CPC H04L 45/566; H04L 45/745; H04L 12/4633

(57) ABSTRACT

A method for a VXLAN extension header for segment routing includes receiving a data packet at a node of a data pathway between an ingress node and an egress node. The data packet includes a tunneling protocol header followed by a segment routing header ahead of a payload and the segment routing header includes a list of identifiers of nodes in the data pathway. The method includes processing the segment routing header to address the data packet to be transmitted to a next node listed in the segment routing header and to update a pointer in the segment routing header, and transmitting the data packet to a next node based on the address of the next node.

### CROSS-REFERENCE TO RELATED APPLICATIONS

This application claims priority to U.S. Provisional Patent Application No. 63/306,380 entitled “TUNNELING EXTENSION HEADER FOR SEGMENT ROUTING” and filed on Feb. 3, 2022 for Corneliu-Ilie Calciu, et al., which is incorporated herein by reference.

### FIELD

The subject matter disclosed herein relates to data segment routing and more particularly relates to a Virtual Extensible Local Area Network (“VXLAN”) extension header for segment routing.

### BACKGROUND

In the computer data industry, segment routing is a source-based routing technique used for traffic engineering and to simplify the routing management. Even though source-based routing was designed for software-defined networking (“SDN”), only majors network players support the segment routing on their SDN solutions.

### BRIEF SUMMARY

A method for a VXLAN extension header for segment routing includes receiving a data packet at a node of a data pathway between an ingress node and an egress node. The data packet includes a tunneling protocol header followed by a segment routing header ahead of a payload and the segment routing header includes a list of identifiers of nodes in the data pathway. The method includes processing the segment routing header to address the data packet to be transmitted to a next node listed in the segment routing header and to update a pointer in the segment routing header, and transmitting the data packet to a next node based on the address of the next node.

An apparatus for a VXLAN extension header for segment routing includes a receiver module configured to receive a data packet at a node of a data pathway between an ingress node and an egress node. The data packet includes a tunneling protocol header followed by a segment routing header ahead of a payload and the segment routing header includes a list of identifiers of nodes in the data pathway. The apparatus includes a processing module configured to process the segment routing header to address the data packet to be transmitted to a next node listed in the segment routing header and to update a pointer in the segment routing header and a transmit module configured to transmit the data packet to a next node based on the address of the next node. The modules include hardware circuits, a programmable hardware device and/or program code stored on computer readable storage media.

Another method for a VXLAN extension header for segment routing includes receiving a data packet at an ingress node of a computer network, where the data packet includes a destination address, identifying nodes in a data pathway from the ingress node to an egress node, and writing a segment routing value to a next type field of a tunneling protocol header of a data packet header of the data packet. The segment routing value indicates that a segment routing header follows the tunneling protocol header and the next type field includes a field indicating a type of a header and/or data following the tunneling protocol header. The method includes adding a segment routing header after the tunneling protocol header. The segment routing header includes a pointer field and an address field, where the address field includes a list of identifiers of nodes in the data pathway. The pointer field includes a value corresponding to a node in the data pathway after a next node in the data pathway after the ingress node. The method includes writing an identifier of the next node in the data pathway to a destination field of the data packet header and transmitting the data packet to the next node.

Another apparatus for a VXLAN extension header for segment routing includes a packet receiver module configured to receive a data packet at an ingress node of a computer network where the data packet includes a destination address, a pathway ID module configured to identify nodes in a data pathway from the ingress node to an egress node, and a next type module configured to write a segment routing value to a next type field of a tunneling protocol header of a data packet header of the data packet. The segment routing value indicates that a segment routing header follows the tunneling protocol header and the next type field includes a field indicating a type of a header and/or data following the tunneling protocol header. The apparatus includes a segment routing (“SW”) header module configured to add a segment routing header after the tunneling protocol header. The segment routing header includes a pointer field and an address field. The address field includes a list of identifiers of nodes in the data pathway and the pointer field includes a value corresponding to a node in the data pathway after a next node in the data pathway after the ingress node. The apparatus includes an initial destination module configured to write an identifier of the next node in the data pathway to a destination field of the data packet header and a transmit module configured to transmit the data packet to the next node.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for a tunneling extension header for segment routing;

FIG. 2 is a schematic block diagram illustrating one embodiment of an apparatus for an intermediate node for a tunneling extension header for segment routing;

FIG. 3 is a schematic block diagram illustrating another embodiment of an apparatus for an intermediate node for a tunneling extension header for segment routing;

FIG. 4 is a schematic block diagram illustrating one embodiment of an apparatus for an ingress node for a tunneling extension header for segment routing;

FIG. 5 is a schematic block diagram illustrating another embodiment of an apparatus for an ingress node for a tunneling extension header for segment routing;

FIG. 6 is a flowchart diagram illustrating one embodiment of a method at an intermediate node for processing a tunneling extension header for segment routing;

FIG. 7 is a flowchart diagram illustrating another embodiment of a method at an intermediate node for processing a tunneling extension header for segment routing;

FIG. 8 is a flowchart diagram illustrating one embodiment of a method at an ingress node for setting up a data packet with a tunneling extension header for segment routing and transmitting the data packet;

FIG. 9 is a flowchart diagram illustrating another embodiment of a method at an ingress node for setting up a data packet with a tunneling extension header for segment routing and transmitting the data packet; and

FIG. 10 is a schematic block diagram illustrating processing an incoming data packet with a Virtual Extensible Local Area Network (“VXLAN”) header and a transition to include a segment routing header.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for a VXLAN extension header for segment routing includes receiving a data packet at a node of a data pathway between an ingress node and an egress node. The data packet includes a tunneling protocol header followed by a segment routing header ahead of a payload and the segment routing header includes a list of identifiers of nodes in the data pathway. The method includes processing the segment routing header to address the data packet to be transmitted to a next node listed in the segment routing header and to update a pointer in the segment routing header, and transmitting the data packet to a next node based on the address of the next node.

In some embodiments, processing the segment routing header to address the data packet to be transmitted to the next node listed in the segment routing header and to update the pointer in the segment routing header includes reading the pointer in the segment routing header, reading a next node identifier in a node identifier list of the segment routing header where the node identifier corresponds to a value of the pointer, writing the next node identifier in a destination field of a packet header of the data packet, and decrementing the pointer. In other embodiments, the tunneling protocol is VXLAN or Generic Network Virtualization Encapsulation (“GENEVE”). In other embodiments, the tunneling protocol header includes a next type field with a value that indicates that the segment routing header follows the tunneling protocol header. The next type field includes a field indicating a type of a header and/or data following the tunneling protocol header.

In some embodiments, the segment routing header includes a length field with a value indicating a length of the segment routing header, a pointer field with a current value of the pointer, a next type field with a value indicating a protocol of the payload and/or an address field with the list of identifiers of nodes in the data pathway. The next type field includes a field indicating a type of a header and/or data following the tunneling protocol header. In other embodiments, the identifiers of nodes in the data pathway include internet protocol (“IP”) addresses. In other embodiments, the identifiers of nodes in the data pathway each include a node identifier where the node that received the data packet includes a table correlating IP addresses of the nodes in the data pathway and corresponding node identifiers. In other embodiments, the method includes comparing nodes that the data packet traveled to the list of nodes in the data pathway in the segment routing header and sending an alert if the data packet traveled to a node other than nodes in the list of nodes in the data pathway.

An apparatus for a VXLAN extension header for segment routing includes a receiver module configured to receive a data packet at a node of a data pathway between an ingress node and an egress node. The data packet includes a tunneling protocol header followed by a segment routing header ahead of a payload and the segment routing header includes a list of identifiers of nodes in the data pathway. The apparatus includes a processing module configured to process the segment routing header to address the data packet to be transmitted to a next node listed in the segment routing header and to update a pointer in the segment routing header and a transmit module configured to transmit the data packet to a next node based on the address of the next node. The modules include hardware circuits, a programmable hardware device and/or program code stored on computer readable storage media.

In some embodiments, the processing module includes a pointer position module configured to read the pointer in the segment routing header, a next node module configured to read a next node identifier in a node identifier list of the segment routing header where the node identifier corresponds to a value of the pointer, a destination module configured to write the next node identifier in a destination field of a packet header of the data packet, and a pointer change module configured to decrement the pointer. In other embodiments, the tunneling protocol header includes a next type field with a value that indicates that the segment routing header follows the tunneling protocol header and the next type field includes a field indicating a type of a header and/or data following the tunneling protocol header. In other embodiments, the segment routing header includes a length field with a value indicating a length of the segment routing header, a pointer field with a current value of the pointer, a next type field with a value indicating a protocol of the payload and/or an address field with the list of identifiers of nodes in the data pathway. The next type field includes a field indicating a type of a header and/or data following the tunneling protocol header.

In some embodiments, the identifiers of nodes in the data pathway each include a node identifier, where the node that received the data packet includes a table correlating IP addresses of the nodes in the data pathway and corresponding node identifiers. In other embodiments, the apparatus includes a security module configured to compare nodes that the data packet traveled to the list of nodes in the data pathway in the segment routing header and sending an alert if the data packet traveled to a node other than nodes in the list of nodes in the data pathway.

Another method for a VXLAN extension header for segment routing includes receiving a data packet at an ingress node of a computer network, where the data packet includes a destination address, identifying nodes in a data pathway from the ingress node to an egress node, and writing a segment routing value to a next type field of a tunneling protocol header of a data packet header of the data packet. The segment routing value indicates that a segment routing header follows the tunneling protocol header and the next type field includes a field indicating a type of a header and/or data following the tunneling protocol header. The method includes adding a segment routing header after the tunneling protocol header. The segment routing header includes a pointer field and an address field, where the address field includes a list of identifiers of nodes in the data pathway. The pointer field includes a value corresponding to a node in the data pathway after a next node in the data pathway after the ingress node. The method includes writing an identifier of the next node in the data pathway to a destination field of the data packet header and transmitting the data packet to the next node.

In some embodiments, includes adding the tunneling protocol header to the header of the data packet in response to the received data packet lacking a tunneling protocol header. In other embodiments, the tunneling protocol includes VXLAN or GENEVE. In other embodiments, the data packet is received from a tunnel endpoint. In other embodiments, the segment routing header includes a length field with a value indicating a length of the segment routing header and/or a next type field with a value indicating a protocol of a payload of the data packet. The next type field includes a field indicating a type of a header and/or data following the tunneling protocol header. In other embodiments, the list of nodes in the data pathway are arranged in an order of travel of the data packet to the egress node and a pointer value of zero corresponds to the egress node. In other embodiments, the identifiers of nodes in the data pathway are IP addresses. In other embodiments, the identifiers of nodes in the data pathway each include a node identifier where each node in the data pathway includes a table correlating IP addresses of the nodes in the data pathway and node corresponding identifiers.

Another apparatus for a VXLAN extension header for segment routing includes a packet receiver module configured to receive a data packet at an ingress node of a computer network where the data packet includes a destination address, a pathway ID module configured to identify nodes in a data pathway from the ingress node to an egress node, and a next type module configured to write a segment routing value to a next type field of a tunneling protocol header of a data packet header of the data packet. The segment routing value indicates that a segment routing header follows the tunneling protocol header and the next type field includes a field indicating a type of a header and/or data following the tunneling protocol header. The apparatus includes a segment routing (“SW”) header module configured to add a segment routing header after the tunneling protocol header. The segment routing header includes a pointer field and an address field. The address field includes a list of identifiers of nodes in the data pathway and the pointer field includes a value corresponding to a node in the data pathway after a next node in the data pathway after the ingress node. The apparatus includes an initial destination module configured to write an identifier of the next node in the data pathway to a destination field of the data packet header and a transmit module configured to transmit the data packet to the next node.

In some embodiments, the apparatus includes a tunneling header module configured to add the tunneling protocol header to the data packet header of the data packet in response to the received data packet lacking a tunneling protocol header. In other embodiments, the segment routing header includes a length field with a value indicating a length of the segment routing header and/or a next type field with a value indicating a protocol of a payload of the data packet. The next type field includes a field indicating a type of a header and/or data following the tunneling protocol header. In other embodiments, the list of nodes in the data pathway are arranged in an order of travel of the data packet to the egress node and a pointer value of zero corresponds to the egress node.

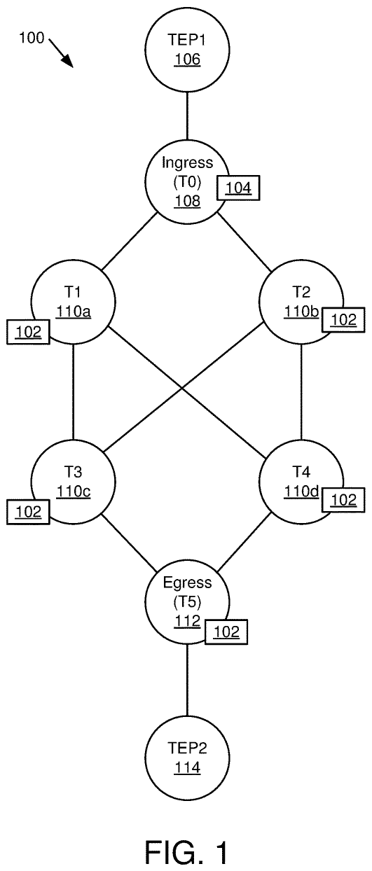

FIG. 1 is a schematic block diagram illustrating one embodiment of a system 100 for a tunneling extension header for segment routing. The system 100 includes segment processing apparatuses 102, a segment header apparatus 104, a first tunneling endpoint 106, an ingress node 108 with the segment header apparatus 104, intermediate nodes 110a-110d (collectively or generically “110”) and an egress node 112 each with a segment processing apparatus 102, and a second tunneling endpoint 114, which are described below. In some embodiments, the system 100 includes a computer network.

Many current networks use border gateway protocol (“BGP”), which is a standardized exterior gateway protocol designed to exchange routing and reachability information among autonomous systems (“AS”) on the Internet. BGP is classified as a path-vector routing protocol, and it makes routing decisions based on paths, network policies, or rule-sets configured by a network administrator. Other systems legacy systems include the intermediate system-to-intermediate system (“IS-IS”) protocol, which is a routing protocol designed to move information efficiently within a computer network, a group of physically connected computers or similar devices. IS-IS accomplishes this by determining the best route for data through a packet switching network. BGP and IS-IS as well as other current networks typically use large routing tables.

Segment routing is a source-based routing technique that simplifies data traffic management across network domains. Segment routing removes network state information from intermediate nodes and places path state information in packet headers at an ingress node. Thus, intermediate routers using segment routing do not have to access the large routing tables, which reduces router logic and processing time. In segment routing, the ingress node determines a data pathway to a destination address and each intermediate node along the data pathway and places node addresses or node identifiers in the header of the data packets. Upon receiving a data packet, an intermediate node reads an address or identifier of a next node and places the next node address/identifier in a destination field of the header and transmits the data packet to the next node, which decreases processing time.

Other solutions have significant disadvantages. For example, multiprotocol label switching (“MPLS”), which is a segment routing protocol, requires level 2 connectivity between routing nodes because the MPLS header is before the layer 3 (Internet Protocol (“IP”)) header. Also, MPLS will not work across domains and does not function over the Internet. Segment routing for Internet Protocol version 4 (“IPv4”) has an ability to add options, such as a segment routing header, but IPv4 segment routing protocols such as strict source route (“SSR”) and loose source route (“LSR”) protocols again do not span domains and are not accepted by Internet service providers (“ISPs”) due to security concerns associated with variable headers required for the segment routing protocols. IPv6 segment routing protocols have the same problem as IPv4 segment routing protocols and additionally require larger headers, which increases processing time.

The system 100 includes a segment processing apparatus 102 in intermediate nodes 110 and a segment header apparatus 104 in an ingress node 108. The segment processing apparatus 102 and the segment header apparatus 104 provide a mechanism to add segment routing to data packets configured for tunneling protocols by customizing a next type field in a tunneling protocol header to signify that a segment routing header follows the tunneling protocol header. Tunneling protocols are typically able to span domains and to operate over the Internet in addition to operating within a proprietary network.

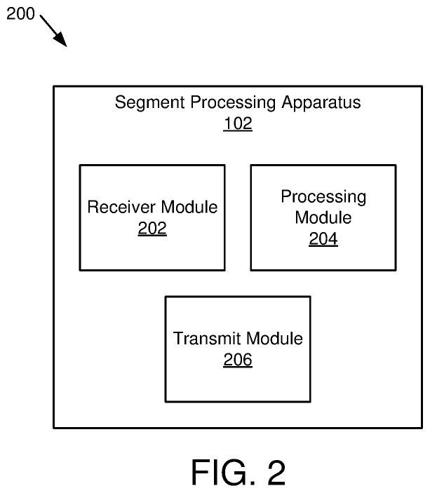

such as Virtual Extensible Local Area Network (“VXLAN”) and Generic Network Virtualization Encapsulation (“GENEVE”), by using a next type field that identifies a protocol or a header that will follow the tunneling protocol header. For example, VXLAN includes a generic protocol extension (“GPE”) version that includes a Next Protocol field that allows a user to add a value that signifies a next protocol type different than standard protocol types required in the past. The Next Protocol field may be exploited to include a value signaling that a segment routing header follows the VXLAN header. GENEVE also includes a flexible option header format with a Variable Length Options field that may be used to signal inclusion of a segment routing header after the GENEVE header. Advantageously, the segment processing apparatus 102 and the segment header apparatus 104 provide a mechanism to include segment routing for data packets transmitted across domains and via the Internet. The segment processing apparatus 102 and the segment header apparatus 104 are described in more detail below with regards to the apparatuses 200, 300, 400, 500 of FIGS. 2, 3, 4, and 5.

The system 100 includes a first tunnel endpoint 106 and a second tunnel endpoint 114 configured to initiate and terminate a data packet transmission tunnel. At the first tunnel endpoint 106, in some embodiments, each data packet destined for the second tunnel endpoint 114 is encapsulated with a tunneling protocol header and transmitted to the ingress node 108. In other embodiments, the ingress node encapsulates each data packet with a tunneling protocol header. For example, where the first and second tunnel endpoints are servers not set to use a tunneling protocol, the segment header apparatus 104 in the ingress node 108 may encapsulate the data packet with a tunneling protocol header to be able to include the segment routing header and take advantage of the features and benefits of the embodiments described herein. The first and second tunnel endpoints 106, 114 may be physical or virtual switch ports that send and receive data packets from servers, virtual machines, or other computing devices. In some embodiments, one or both of the first and second tunnel endpoints 106, 114 are in a datacenter and/or cloud computing facility.

VXLAN is a network virtualization protocol developed to address scalability problems associated with large cloud computing deployments. The tunnel endpoints 106, 114 are VXLAN tunnel endpoints and may be virtual or physical switch ports. VXLAN increases scalability over a virtual local area network (“VLAN”) with up to 16 million logical networks and allows layer-2 adjacency across IP networks. A recent version of VXLAN is VXLAN GPE. VXLAN is widely used currently.

GENEVE is an emerging network virtualization technology, which is also known as an overlay tunnel protocol. VXLAN is a media access control (“MAC”)-in-IP encapsulation over IP/UDP (UDP is User Datagram Protocol) that includes a MAC-header within the tunneled or encapsulated packets, which is desirable for bridging cases. With routing the MAC-header becomes unnecessary. GENEVE offers flexibility and extensibility and incorporates Generic Routing Encapsulation (“GRE”), VXLAN and GPE use-cases and also includes an ability to use new use cases, such as inclusion of a segment routing protocol. The segment processing apparatus 102 and the segment header apparatus 104 may be used with VXLAN, GENEVE or other tunneling protocol that has an ability to include a segment routing header after the tunneling protocol header.

The intermediate nodes 110, in some embodiments, are routers. Routers are networking devices that forward data packets between computer networks. Typically, routers perform traffic directing functions on the Internet. The routers receive a data packet, process packet header information, and forward the data packet based on a destination address in the packet header. Typically, routers are connected to other routers, tunnel endpoints 106, 114 or other computing devices. For a particular data pathway, one router is designated as an ingress node 108 that is connected to the first tunnel endpoint 106 that transmits data packets on the data pathway and one router is an egress node 112 connected to the second tunnel endpoint 114 that is the destination of the data packets traveling along the data pathway.

Routers include information about other routers and computing devices to which the routers are connected. The information may include an address or a node identifier of the connected routers. Typically, the ingress node 108, intermediate nodes 110, and egress node 112 are connected to other nodes 108, 110, 112. Typically, routers include ports that are connected to other routers and the ports include one or more queues. Data packets are stored in the queues prior to processing and transmission. Often, the queues are each associated with a particular service level where some queues have priority over other queues. One of skill in the art will recognize other features and functions of routers serving as ingress nodes 108, intermediate nodes 110 and egress nodes 112.

The egress node 112 is connected to the second tunnel endpoint 114, which is the destination for the data packets transmitted along the data pathway. Typically, the egress node 112 strips headers from the data packet and transmits the data packet to the second tunnel endpoint 114. In some embodiments, the egress node 112 strips headers above the tunnel protocol header and the second tunnel endpoint 114 strips off the tunnel protocol endpoint.

FIG. 2 is a schematic block diagram illustrating one embodiment of an apparatus 200 for an intermediate node for a tunneling extension header for segment routing. The apparatus 200 includes one embodiment of the segment processing apparatus 102 that includes a receiver module 202, a processing module 204 and a transmit module 206, which are described below. The segment processing apparatus 102, in some embodiments, is implemented in code stored on computer readable storage media. In other embodiments, the segment processing apparatus 102 is implemented with a programmable hardware device, such as an FPGA, and/or fully or partially implemented with hardware circuits, such as an application-specific integrated circuit (“ASIC”).

The apparatus 200 includes a receiver module 202 configured to receive a data packet at a node of a data pathway between an ingress node 108 and an egress node 112. The data packet includes a tunneling protocol header followed by a segment routing header ahead of a payload. The segment routing header includes a list of identifiers of nodes in the data pathway. For example, the data pathway from the ingress node 108 may be through intermediate node T1 110a, intermediate node T4 110d, egress node T5 112 and tunnel endpoint 2 114. In some embodiments, the list of identifiers of nodes in the data pathway include IP addresses. In other embodiments, the list of identifiers of nodes in the data pathway include a node identifier, which may be shorter than a full IP address.

The tunneling protocol header includes, in some embodiments, a next type field with a value that indicates that the segment routing header follows the tunneling protocol header. The next type field is a field indicating a type of a header and/or data following the tunneling protocol header. Where the tunneling protocol header is a VXLAN header, the next type field is a Next Protocol field. Values of the Next Protocol field in other embodiments may include standard values such as 0x01 for IPv4, 0x02 for IPv6, 0x03 for Ethernet. In embodiments described herein, the value for the Next Protocol field is set to a value such that the segment processing apparatus 102 recognizes that a segment routing protocol follows the VXLAN header. For example, values 0x05 to 0x7D are unassigned and may be used to identify that a segment routing header follows the VXLAN header. In other embodiments, the tunneling protocol is GENEVE and the next type field is the Variable Length Options field. Where GENEVE is used, the Variable Length Options field includes a value that indicates to the segment processing apparatus 102 that a segment routing header follows the GENEVE header.

The segment routing header, in some embodiments, includes at least a pointer field and an address field that includes the list of identifiers of nodes in the data pathway. In some embodiments, the list of identifier of nodes in the data pathway is arranged in order so that the pointer traversing the list indicates a next node 110 after the current node 110. In other embodiments, the egress node 112 is arranged in the list of identifiers so that a pointer value of zero corresponds to the identifier for the egress node 112. For example, where the data pathway is the ingress node T0 108, node T1 110a, node T4 110d, and the egress node T5 112, the list of identifiers in the segment routing header may be T1, T4, and T5. The pointer values will then be 2, 1, and 0 so that a pointer value of 2 points to node T1 110a, a pointer value of 1 points to node T4 110d, and a pointer value of zero points to the egress node T5 112. The data packet header includes the address of the second tunnel endpoint 114.

In other embodiments, the pointer increments at each hop. In the embodiment, the pointer value for the egress node 112 is stored so that when the pointer reaches the pointer value for the egress node 112, the segment processing apparatus 104 recognizes that the current node is the egress node 112. However, these embodiments take more processing time and memory than if the pointer counts down to zero.

In other embodiments, the segment routing header includes a length field with value indicating a length of the segment routing header. The number of hops in the data pathway is not fixed so the list of indicators in the list of nodes in the data pathway varies in size. The length field is used to change the size of the segment routing header based on changes in the size of the address field. In other embodiments, the size of the address field is fixed and accommodates a particular number of identifiers in the list of nodes in the data pathway. A variable length address field is desirable so that the address field is not larger than needed.

In some embodiments, the segment router header includes a next type field with a value indicating a protocol of the payload. The next type field in the segment router header indicates the protocol of the encapsulated payload and may include values that correspond to protocol types such as IPv4, IPv6, Ethernet, etc.

The apparatus 200 includes a processing module 204 configured to process the segment routing header to address the data packet to be transmitted to a next node listed in the segment routing header and to update a pointer in the segment routing header. Addressing the data packet to be transmitted to the next node includes determining the address or identifier corresponding to the next node 110. The pointer is read to determine the identifier of the next node 110. The identifier, whether it be an IP address or other node identifier, is written to the destination field of the packet header. The processing module 204 also updates the pointer to point to the next identifier in the address field of the segment routing header, which prepares the data packet to be read by the segment processing apparatus 102 in the next node 110.

The apparatus 200 includes a transmit module 206 configured to transmit the data packet to a next node based on the address of the next node. The transmit module 206 reads the address in the destination field in the data packet header to determine where the data packet is to be transmitted. The address in the destination field may be an IP address or a node identifier. In some embodiments, the transit module 206 places the data packet in a queue of a port connected to the next node 110.

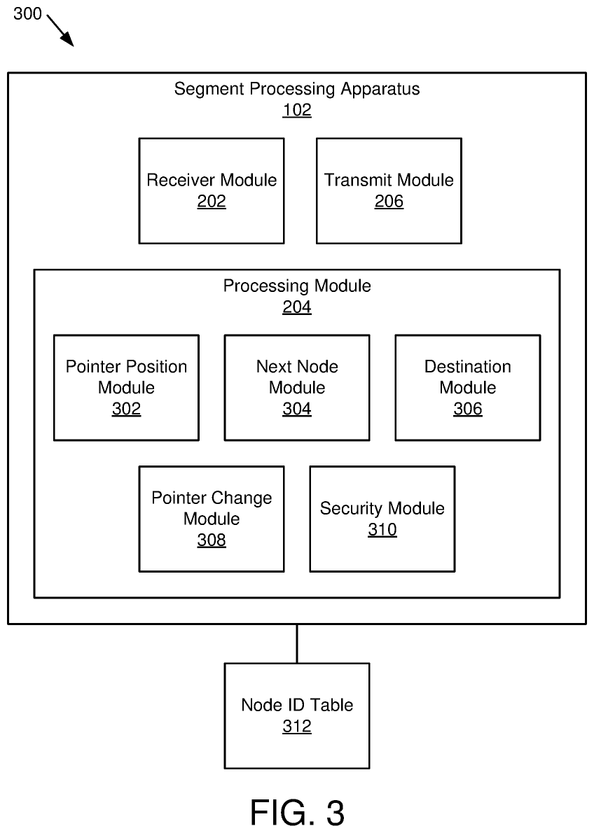

FIG. 3 is a schematic block diagram illustrating another embodiment of an apparatus 300 for an intermediate node for a tunneling extension header for segment routing. The apparatus 300 includes another embodiment of the segment processing apparatus 102 with a receiver module 202, a processing module 204, and a transmit module 206, which are substantially similar to those described above in relation to the apparatus 200 of FIG. 2. In various embodiments, the processing module 204 of the apparatus 300 includes a pointer position module 302, a next node module 304, a destination module 306, a pointer change module 308, and/or a security module 310 and, in some embodiments, the apparatus 300 is communicatively coupled to a node ID table 312. The apparatus 300, in various embodiments, is implemented similarly to the apparatus 200 of FIG. 2.

The apparatus 300 includes, in some embodiments, a pointer position module 302 configured to read a pointer in the segment routing header. The pointer position module 302 determines a value of the pointer, in some embodiments, prior to updating the pointer. Continuing with the example above where the data pathway is ingress node T0 108, node T1 110a, node T4 110d, and egress node T5 112, the pointer could have a value of 2 for node T1 110a, 1 for node T4 110d, or 0 for egress node T5 112. For example, if the data packet is in node T1 110a, the destination field of the data packet has an address of the node T1 110a and the pointer would be set to the next node T4 110d of the data pathway and would have a value of 1.

The apparatus 300, in some embodiments, includes a next node module 304 configured to read a next node identifier in a node identifier list of the segment routing header where the node identifier corresponds to a value of the pointer. In the example above the next node module 304 would read a node identifier in a first position, which would correspond to node T4 110d. The apparatus 300, in some embodiments, includes a destination module 306 configured to write the next node identifier in a destination field of a packet header of the data packet. In some embodiments, the destination field is in a layer 3 header along with a source field.

The apparatus 300, in some embodiments, includes a pointer change module 308 configured to decrement the pointer. The pointer change module 308 decrements the pointer prior to the transmit module 206 transmitting the data packet to the next node 110, which in the example is node T4 110. In the example, since the pointer value was a “1” when the data packet was received, the pointer change module 308 changes the pointer to a “0,” which corresponds to the egress node T5 112.

In some embodiments, the apparatus 300 includes a security module 310 configured to compare nodes that the data packet traveled to the list of nodes in the data pathway in the segment routing header and sends an alert if the data packet traveled to a node other than nodes in the list of nodes in the data pathway. The segment routing header includes the intended path of the data path in the address field. Where header information includes information about nodes where the data packet was transmitted, the security module 310 compares the actual data path with the list of identifiers for nodes in the data pathway and sends an alert if the actual data path does not match with the data pathway as listed in the address field of the segment routing header.

Where the node identifiers are not IP addresses but are instead some form of a node identifier that is insufficient to identify a next node, the routers of the nodes 108, 110, 112 include a node ID table 312 correlating IP addresses of the nodes in the data pathway and corresponding node identifiers. Beneficially, the node identifiers may be shorter than IP addresses, which allow the address field in the segment routing header to be smaller than if IP addresses are used.

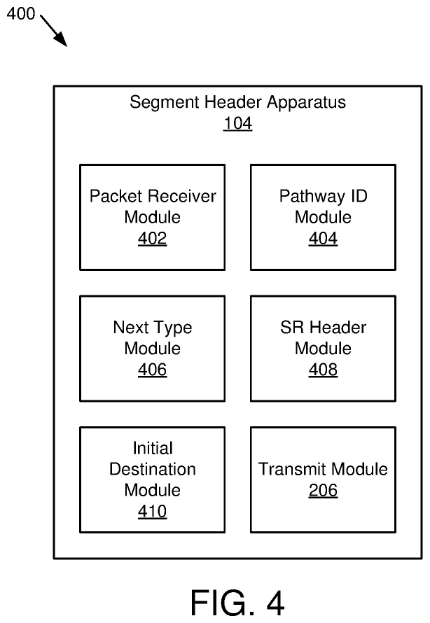

FIG. 4 is a schematic block diagram illustrating one embodiment of an apparatus 400 for an ingress node for a tunneling extension header for segment routing. The apparatus 400 includes one embodiment of a segment header apparatus 104 with a packet receiver module 402, a pathway ID module 404, a next type module 406, a segment routing (“SW”) header module 408, an initial destination module 410, and the transmit module 206, which are described below. The segment header apparatus 104, in some embodiments, is implemented in code stored on computer readable storage media. In other embodiments, the segment header apparatus 104 is implemented with a programmable hardware device, such as an FPGA, and/or fully or partially implemented with hardware circuits, such as an ASIC.

The apparatus 400 includes a packet receiver module 402 configured to receive a data packet at an ingress node 108 of a computer network. The data packet includes a destination address. In some embodiments, the packet receiver module 402 receives the data packet from a tunnel endpoint, such as the first tunnel endpoint 106. Where the packet receiver module 402 receives the data packet from a tunnel endpoint, the data packet may include a tunneling protocol header. In other embodiments, the data packet does not include a tunneling protocol header and the packet receiver module 402 may receive the data packet from a server or other computing device.

The data packet includes a destination address and may also include a source address. For example, the source and destination addresses may be in a layer-3 header of a data packet header for the data packet. A data packet header, as used herein, refers to header information of the data packet ahead of a payload. The data packet header changes through processing by the segment header apparatus 104 and the segment processing apparatus 102 along with other routing processes.

The segment header apparatus 104 is at an ingress node, such as the ingress node T0 108 of the system 100. The ingress node T0 108 serves as an ingress node for some data packets but serves as an egress node for data packets being transmitted to the first tunnel endpoint 106. In other embodiments, the ingress node T0 108 may be an intermediate node for other data pathways not depicted in the system 100 of FIG. 1.

The apparatus 400 includes a pathway ID module 404 configured to identify nodes in a data pathway from the ingress node to an egress node. The pathway ID module 404, in some embodiments, selects a most efficient data pathway based on network traffic. In other embodiments, the pathway ID module 404 selects a data pathway based on other factors, such as node availability, service level agreements, which nodes are designated as primary and which are designated as backup, etc. For example, the pathway ID module 404 may select a data pathway from the ingress node T0 108 to node T1 110a, to node T4 110d, and to the egress node T5 112 based on various factors. In some embodiments, the pathway ID module 404 uses segment routing protocol techniques to select the data pathway.

The apparatus 400 includes a next type module 406 configured to write a segment routing value to a next type field of a tunneling protocol header of a header of the data packet. The segment routing value indicates that a segment routing header follows the tunneling protocol header. As described above, various tunneling protocols, such as VXLAN and GENEVE include a next type field that allows writing a value that corresponds to a segment router header following the tunneling protocol header. In some examples, the segment processing apparatus 102 recognizes the value in the next type field corresponding to a segment routing header and treats a received data packet as having a segment routing header.

In general, the next type field is a field indicates a type of a header and/or data following the tunneling protocol header and may be used by other routing protocols to indicate that what follows the tunneling protocol header has a protocol that is IPv4, IPv6, Ethernet, some other custom header, or the like. The embodiments described herein utilize the next type fields, such as the Next Protocol field of a VXLAN header or a Variable Length Options field of a GENEVE header, to indicate that a segment routing header follows the tunneling protocol header.

The apparatus 400 includes an SR header module 408 configured to add a segment routing header after the tunneling protocol header. The segment routing header includes at least a pointer field and an address field. The address field includes a list of identifiers of nodes in the data pathway. In some embodiments, the SR header module 408 writes in the address field the node indicators of the data pathway identified by the pathway ID module 404. In some embodiments, the SR header module 408 writes the node identifiers in a sequence that corresponds to how the data packet will travel the data pathway with the egress node 112 corresponding to a pointer value of zero.

The pointer field includes a value corresponding to a node in the data pathway after a next node in the data pathway after the ingress node 108. In the example above, the ingress node T0 108 is the first stop for the data packet, node T1 110a is the next node, and node T4 110d is the node in the data pathway after the next node. Node T4 110d corresponds to a pointer value of “1” so the SR header module 408 writes a “F” to the pointer field. In some embodiments, the SR header module 408 also writes a value to a length field of the segment routing header that indicates a length of the segment routing header. The length varies based on how many node identifiers are in the address field.

The apparatus 400 includes an initial destination module 410 configured to write an identifier of the next node in the data pathway to a destination field of the header of the data packet. The next node is from the data pathway identified by the pathway ID module 404. In the example above, the next node is node T1 110a so that initial destination module 410 writes the node identifier in the destination field of the data packet header. In some embodiments, the initial destination module 410 writes the next node identifier in the layer-3 destination field. In some embodiments, the initial destination module 410 writes an IP address of the next node in the destination field. In other embodiments, the initial destination module 410 writes a node identifier that is not the IP address.

Once the next type module 406 as written a segment routing value to the next type field of the tunneling protocol header, the SR header has added the segment routing header after the tunneling protocol header, and the initial destination module 410 has written the next node identifier to the destination field, the transmit module 206 transmits the data packet to the next node (e.g. node T1 110a). In some embodiments, transmitting the data packet includes adding the data packet to an appropriate queue of a port connected to the next node.

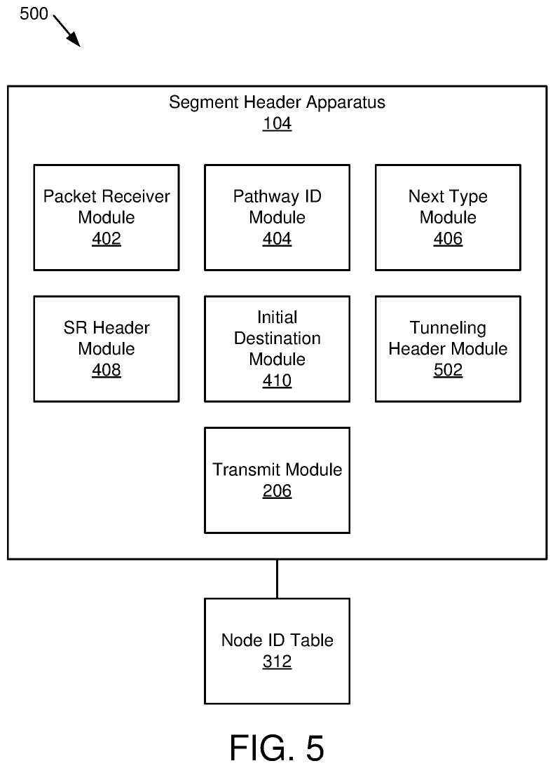

FIG. 5 is a schematic block diagram illustrating another embodiment of an apparatus 500 for an ingress node for a tunneling extension header for segment routing. The apparatus 500 includes another version of the segment header apparatus 104 with a packet receiver module 402, a pathway ID module 404, a next type module 406, an SR header module 408, an initial destination module 410, and the transmit module 206, which are substantially similar to those described above in relation to the apparatus 400 of FIG. 4. The apparatus 500 includes, in various embodiments, a tunneling header module 502 and the segment header apparatus 104 is communicatively coupled to a node ID table 312. The apparatus 500, in some embodiments, is implemented in a similar way as the apparatus 400 of FIG. 4.

The apparatus 500 includes, in some embodiments, a tunneling header module 502 configured to add the tunneling protocol header to the header of the data packet in response to the received data packet lacking a tunneling protocol header. In some embodiments, the ingress node 108 receives the data packet from the first tunnel endpoint 106 but the first tunnel endpoint 106, which is configured as a tunnel endpoint of tunnel between tunnel endpoints, does not add the tunneling protocol header. For example, the first tunnel endpoint 106 may direct the tunneling header module 502 to add the tunneling protocol header. In other embodiments, the ingress node 108 is connected to a server or other computing device not configured for tunneling so the tunneling header module 502 adds the tunneling protocol header to the data packet to take advantage of the benefit of the segment header apparatus 104 and the segment processing apparatus 102.

As with the segment processing apparatus 102, where the node identifiers are not IP addresses but are instead some form of a node identifier that is insufficient to identify a next node, the routers of the nodes 108, 110, 112 include a node ID table 312 correlating IP addresses of the nodes in the data pathway and corresponding node identifiers. Beneficially, the node identifiers may be shorter than IP addresses, which allow the address field in the segment routing header to be smaller than if IP addresses are used.

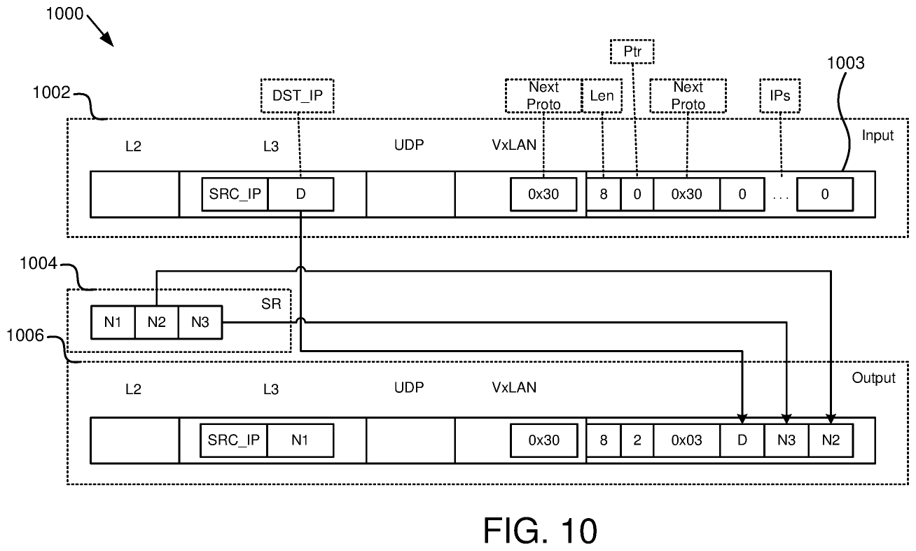

FIG. 10 is a schematic block diagram 1000 illustrating processing an incoming data packet with a Virtual Extensible Local Area Network (“VXLAN”) header and a transition to include a segment routing header. The incoming data packet includes a packet header 1002 and L2 header followed by an L3 header that includes a source address labeled SRC_IP and a Destination field (“DST_IP”) for a destination address D, which is the egress node 112. A UDP header is next followed by a VXLAN header. The VXLAN header includes a Next Protocol field (“Next Proto”) with a value of 0x30, which is a custom value used to indicate that a segment routing header 1003 follows the VXLAN header. The 0x30 value is added at the ingress node 108. While the Next Protocol field is depicted, the VXLAN header includes other fields, which are not shown. The L2, L3 and UDP also include other fields which are not shown. The segment routing header 1003 includes a Length field (“Len”) with a value of 8, a Pointer field (“Ptr”) includes a value of “0,” a Next Protocol field (“Next Proto”) has a value of 0x03, and an Address field (“IPs”) include initially values of zero. The Length field value represents the length of the segment routing header 1003. The Pointer field and Address fields are shown with zeros as initial values before being changed.

The data pathway 1004 is depicted below the packet header 1002 and indicates that the data pathway is node N1, node N2 and node N3, which are intermediate nodes 110 before the egress node 112, which is “D” in the diagram 1000. The data packet header 1006 at the output just before transmission is depicted at the bottom. The next node N1 after the ingress node 108 is depicted in the Destination field of the L3 header. The Next Protocol field of the VXLAN header is 0x30, which is a custom value indicating to intermediate nodes 110 that a segment routing header 1003 follows the VXLAN header. The Length field has a value of “8,” which indicate a length of the segment routing header 1003 with the Address field filled in with the indicators for the nodes in the data pathway.

The Pointer field is set to “2,” which is decremented to a value of “0” as the data packet proceeds to the egress node 112. Thus, the next node N1 will read the Pointer value of “2” and will look to the Address field at a position that corresponds to a pointer value of 2, which is the N2 value. A Pointer field value of “1” will point to N3 and a Pointer field value of “0” will point to D, which is the address of the egress node 112. The Next Prototype field of the segment routing header 1003 indicates the protocol of the payload of the data packet. The segment header apparatus 104 determines the data pathway 1004 and populates the fields of the segment routing header 1003.

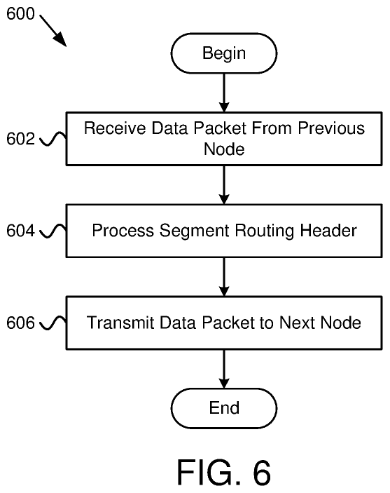

FIG. 6 is a flowchart diagram illustrating one embodiment of a method 600 at an intermediate node for processing a tunneling extension header for segment routing. The method 600 begins and receives 602 a data packet at a node 110 of a data pathway between an ingress node 108 and an egress node 112. The data packet includes a tunneling protocol header followed by a segment routing header ahead of a payload. The segment routing header includes a list of identifiers of nodes 108, 110, 112 in the data pathway. The method 600 processes 604 the segment routing header to address the data packet to be transmitted to a next node (e.g. 110a) listed in the segment routing header and to update a pointer in the segment routing header. The method 600 transmits 606 the data packet to a next node based on the address of the next node 110a, and the method 600 ends. In various embodiments, all or a portion of the method 600 is implemented using the receiver module 202, the processing module 204, and/or the transmit module 206.

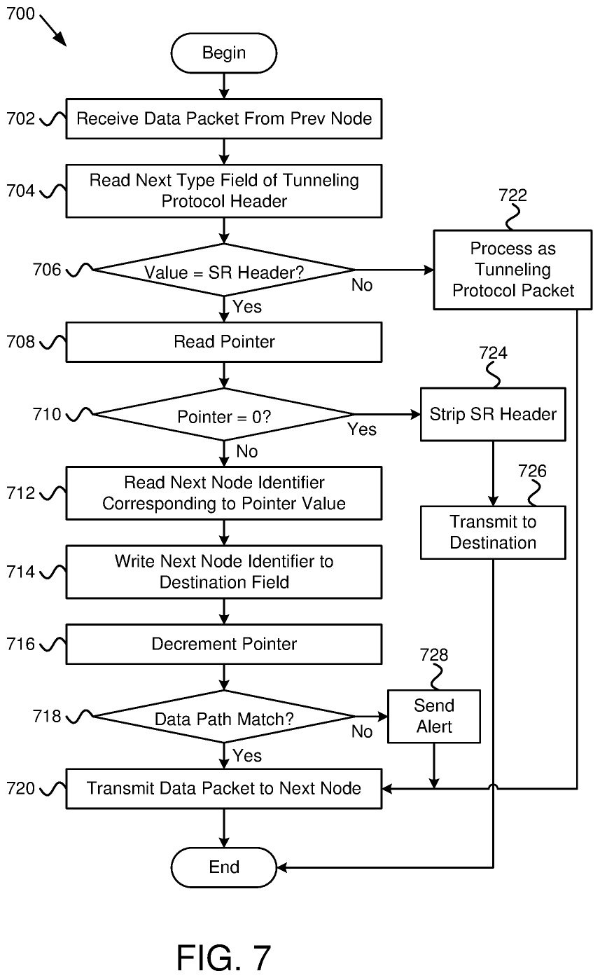

FIG. 7 is a flowchart diagram illustrating another embodiment of a method 700 at an intermediate node for processing a tunneling extension header for segment routing. The method 700 begins and receives 702 a data packet from a previous node in a data pathway from an ingress node 108 to an egress node 112. The previous node may be the ingress node 108 or some other intermediate node 110. The data packet includes a tunneling protocol header, such as a VXLAN header, a GENEVE header, or the like. The method 700 reads 704 a next type field of the tunneling protocol header and determines 706 if the value of the next type field indicates that a segment routing header follows the tunneling protocol header. The next type field is a Next Protocol field for a VXLAN header or a Variable Length Options field for a GENEVE header.

If the method 700 determines 706 that the value of the next type field indicates that a segment routing header follows the tunneling protocol header, the method 700 reads 708 a Pointer field in the segment routing header and determines 710 if the value of the Pointer field is zero. If the method 700 determines 710 that the value of the Pointer field is not zero, the method 700 reads 712 a next node identifier in a node identifier list in the Address field of the segment routing header. The node identifier corresponding to a value of the pointer. The method 700 writes 714 the next node identifier in a destination field of a packet header of the data packet and decrements 716 the value of the Pointer field by one.

The method 700 determines 718, in some embodiments, if an actual data path that the data packet has traveled matches the data path in the Address field of the segment routing header. If the method 700 determines 718 that the actual data path that the data packet traveled matches the data path in the Address field of the segment routing header, the method 700 transmits 720 the data packet to the next node 110 based on the address of the next node in the Destination field of the data packet, and the method 700 ends. If the method 700 determines 706 that the value of the next type field of the tunneling protocol header is not a value that corresponds to a segment routing header following the tunneling protocol header, the method 700 processes 722 the data packet as a typical tunneling protocol packet and the method 700 ends. If the method 700 determines 710 that the value of the Pointer field is zero, the method 700 strips 724 the segment routing header from the data packet and transmits 726 the data packet to the destination, such as the second tunnel endpoint 114, and the method 700 ends. If the method 700 determines 718 that the actual data path that the data packet has traveled does not match the data path in the Address field of the segment routing header, the method 700 sends 728 an alert, and the method 700 ends. In various embodiments, all or a portion of the method 700 is implemented using the receiver module 202, the processing module 204 with the pointer position module 302, the next node module 304, the destination module 306, the pointer change module 308, and/or the security module 310, and/or the transmit module 206, and the method 700 may have access to the node ID table 312.

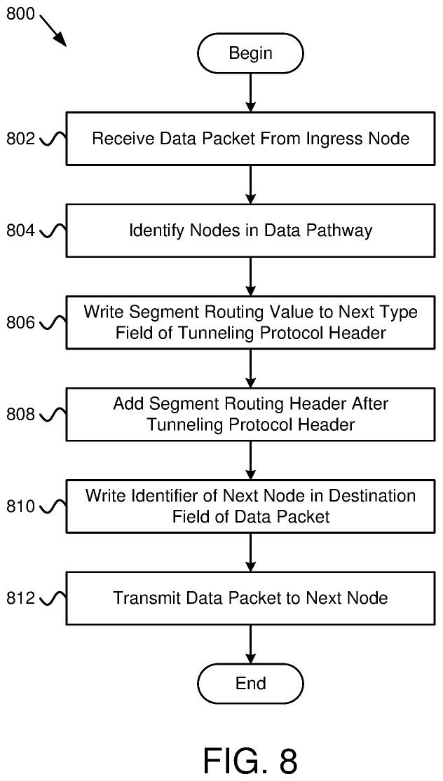

FIG. 8 is a flowchart diagram illustrating one embodiment of a method 800 at an ingress node 108 for setting up a data packet with a tunneling extension header for segment routing and transmitting the data packet. The method 800 begins and receives 802 a data packet at an ingress node 108 of a computer network 100. The data packet includes a destination address. For example, the data packet may be destined for the second tunnel endpoint 114 and may be addressed to the egress node 112, which then transfers the data packet to the second tunnel endpoint 114. The method 800 identifies 804 nodes in a data pathway from the ingress node 108 to an egress node 112 and writes 806 a segment routing value to a next type field of a tunneling protocol header of a data packet header of the data packet. The segment routing value indicates that a segment routing header follows the tunneling protocol header. The next type field is a field that indicates a type of a header and/or data following the tunneling protocol header.

The method 800 adds 808 a segment routing header after the tunneling protocol header. The segment routing header includes a pointer field and an address field where the address field includes a list of identifiers of nodes (e.g. 110, 112) in the data pathway and the pointer field includes a value corresponding to a node (e.g. 110d) in the data pathway after a next node (e.g. 110a) in the data pathway after the ingress node 108. The method 800 includes writing 810 an identifier of the next node 110a in the data pathway to a destination field of the data packet header and transmits 812 the data packet to the next node (e.g. 110a), and the method 800 ends. In various embodiments, all or a portion of the method 800 is implemented using the packet receiver module 402, the pathway ID module 404, the next type module 406, the SR header module 408, the initial destination module 410, and/or the transmit module 206.

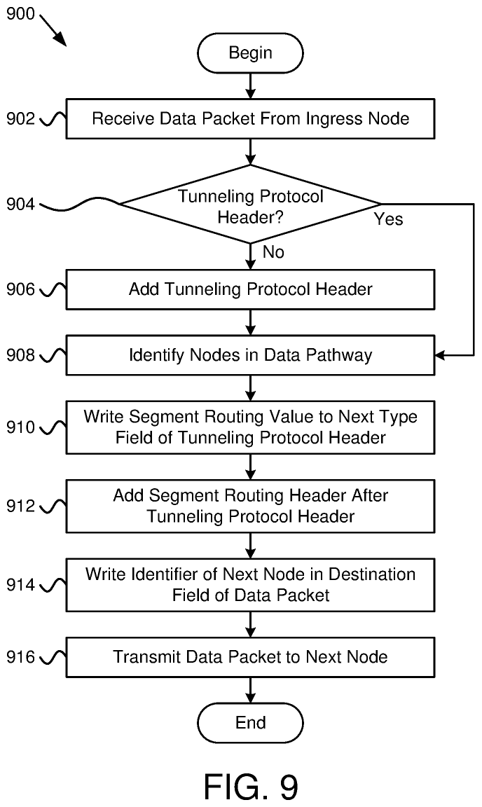

FIG. 9 is a flowchart diagram illustrating another embodiment of a method 900 at an ingress node 108 for setting up a data packet with a tunneling extension header for segment routing and transmitting the data packet. The method 900 begins and receives 902 a data packet at an ingress node 108 of a computer network 100. The data packet includes a destination address. The method 900 determines 904 if the data packet includes a tunneling protocol header. If the method 900 determines 904 that the data packet includes a tunneling protocol header, the method 900 adds 906 a tunneling protocol header to a data packet header of the data packet and identifies 908 nodes in a data pathway from the ingress node 108 to an egress node 112. If the method 900 determines 904 that the data packet includes a tunneling protocol header, the method 900 identifies 908 nodes in a data pathway from the ingress node 108 to an egress node 112.

The method 900 writes 910 a segment routing value to a next type field of a tunneling protocol header of the data packet header. The segment routing value indicates that a segment routing header follows the tunneling protocol header. The next type field is a field that indicates a type of a header and/or data following the tunneling protocol header. The method 900 adds 912 a segment routing header after the tunneling protocol header. The segment routing header includes a pointer field and an address field where the address field includes a list of identifiers of nodes (e.g. 110, 112) in the data pathway and the pointer field includes a value corresponding to a node (e.g. 110d) in the data pathway after a next node (e.g. 110a) in the data pathway after the ingress node 108. The method 900 includes writing 914 an identifier of the next node 110a in the data pathway to a destination field of the data packet header and transmits 916 the data packet to the next node (e.g. 110a), and the method 900 ends. In various embodiments, all or a portion of the method 800 is implemented using the packet receiver module 402, the pathway ID module 404, the next type module 406, the SR header module 408, the initial destination module 410, and/or the transit module 206.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a data packet at a node of a data pathway between an ingress node and an egress node, the data packet comprising a tunneling protocol header followed by a segment routing header ahead of a payload, the segment routing header comprising a list of identifiers of nodes in the data pathway;
processing the segment routing header to address the data packet to be transmitted to a next node listed in the segment routing header and to update a pointer in the segment routing header; and
transmitting the data packet to a next node based on the address of the next node.

2. The method of claim 1, wherein processing the segment routing header to address the data packet to be transmitted to the next node listed in the segment routing header and to update the pointer in the segment routing header comprises:
reading the pointer in the segment routing header;
reading a next node identifier in a node identifier list of the segment routing header, the node identifier corresponding to a value of the pointer;
writing the next node identifier in a destination field of a packet header of the data packet; and
decrementing the pointer.

3. The method of claim 1, wherein the tunneling protocol comprises one of Virtual Extensible Local Area Network (“VXLAN”) and Generic Network Virtualization Encapsulation (“GENEVE”).

4. The method of claim 1, wherein the tunneling protocol header comprises a next type field with a value that indicates that the segment routing header follows the tunneling protocol header, the next type field comprising a field indicating a type of a header and/or data following the tunneling protocol header.

5. The method of claim 1, wherein the segment routing header comprises a length field comprising a value indicating a length of the segment routing header, a pointer field comprising a current value of the pointer, a next type field comprising a value indicating a protocol of the payload and/or an address field comprising the list of identifiers of nodes in the data pathway, the next type field comprising a field indicating a type of a header and/or data following the tunneling protocol header.

6. The method of claim 1, wherein the identifiers of nodes in the data pathway comprise internet protocol (“IP”) addresses.

7. The method of claim 1, wherein the identifiers of nodes in the data pathway each comprise a node identifier, wherein the node that received the data packet comprises a table correlating IP addresses of the nodes in the data pathway and corresponding node identifiers.

8. The method of claim 1, further comprising comparing nodes that the data packet traveled to the list of nodes in the data pathway in the segment routing header and sending an alert if the data packet traveled to a node other than nodes in the list of nodes in the data pathway.

9. An apparatus comprising:
a receiver module configured to receive a data packet at a node of a data pathway between an ingress node and an egress node, the data packet comprising a tunneling protocol header followed by a segment routing header ahead of a payload, the segment routing header comprising a list of identifiers of nodes in the data pathway;
a processing module configured to process the segment routing header to address the data packet to be transmitted to a next node listed in the segment routing header and to update a pointer in the segment routing header; and
a transmit module configured to transmit the data packet to a next node based on the address of the next node,
wherein said modules comprise hardware circuits, a programmable hardware device and/or program code stored on computer readable storage media.

10. The apparatus of claim 9, wherein the processing module comprises:
a pointer position module configured to read the pointer in the segment routing header;
a next node module configured to read a next node identifier in a node identifier list of the segment routing header, the node identifier corresponding to a value of the pointer;
a destination module configured to write the next node identifier in a destination field of a packet header of the data packet; and
a pointer change module configured to decrement the pointer.

11. The apparatus of claim 9, wherein the tunneling protocol header comprises a next type field with a value that indicates that the segment routing header follows the tunneling protocol header, the next type field comprising a field indicating a type of a header and/or data following the tunneling protocol header.

12. The apparatus of claim 9, wherein the segment routing header comprises a length field comprising a value indicating a length of the segment routing header, a pointer field comprising a current value of the pointer, a next type field comprising a value indicating a protocol of the payload and/or an address field comprising the list of identifiers of nodes in the data pathway, the next type field comprising a field indicating a type of a header and/or data following the tunneling protocol header.

13. The apparatus of claim 9, wherein the identifiers of nodes in the data pathway each comprise a node identifier, wherein the node that received the data packet comprises a table correlating IP addresses of the nodes in the data pathway and corresponding node identifiers.

14. The apparatus of claim 9, further comprising a security module configured to compare nodes that the data packet traveled to the list of nodes in the data pathway in the segment routing header and sending an alert if the data packet traveled to a node other than nodes in the list of nodes in the data pathway.

15. A method comprising:
receiving a data packet at an ingress node of a computer network, the data packet comprising a destination address;
identifying nodes in a data pathway from the ingress node to an egress node;
writing a segment routing value to a next type field of a tunneling protocol header of a data packet header of the data packet, the segment routing value indicating that a segment routing header follows the tunneling protocol header, the next type field comprising a field indicating a type of a header and/or data following the tunneling protocol header;
adding a segment routing header after the tunneling protocol header, the segment routing header comprising a pointer field and an address field, the address field comprising a list of identifiers of nodes in the data pathway, the pointer field comprising a value corresponding to a node in the data pathway after a next node in the data pathway after the ingress node;
writing an identifier of the next node in the data pathway to a destination field of the data packet header; and
transmitting the data packet to the next node.

16. The method of claim 15, further comprising adding the tunneling protocol header to the header of the data packet in response to the received data packet lacking a tunneling protocol header.

17. The method of claim 15, wherein the tunneling protocol comprises one of Virtual Extensible Local Area Network (“VXLAN”) and Generic Network Virtualization Encapsulation (“GENEVE”).

18. The method of claim 15, wherein the data packet is received from a tunnel endpoint.

19. The method of claim 15, wherein the segment routing header comprises a length field comprising a value indicating a length of the segment routing header and/or a next type field comprising a value indicating a protocol of a payload of the data packet, the next type field comprising a field indicating a type of a header and/or data following the tunneling protocol header.

20. The method of claim 15, wherein the list of nodes in the data pathway are arranged in an order of travel of the data packet to the egress node and wherein a pointer value of zero corresponds to the egress node.

21. The method of claim 15, wherein the identifiers of nodes in the data pathway comprise internet protocol (“IP”) addresses.

22. The method of claim 15, wherein the identifiers of nodes in the data pathway each comprise a node identifier, wherein each node in the data pathway comprises a table correlating IP addresses of the nodes in the data pathway and node corresponding identifiers.

23. An apparatus comprising:
a packet receiver module configured to receive a data packet at an ingress node of a computer network, the data packet comprising a destination address;
a pathway ID module configured to identify nodes in a data pathway from the ingress node to an egress node;
a next type module configured to write a segment routing value to a next type field of a tunneling protocol header of a data packet header of the data packet, the segment routing value indicating that a segment routing header follows the tunneling protocol header, the next type field comprising a field indicating a type of a header and/or data following the tunneling protocol header;
an SR header module configured to add a segment routing header after the tunneling protocol header, the segment routing header comprising a pointer field and an address field, the address field comprising a list of identifiers of nodes in the data pathway, the pointer field comprising a value corresponding to a node in the data pathway after a next node in the data pathway after the ingress node;
an initial destination module configured to write an identifier of the next node in the data pathway to a destination field of the data packet header; and
a transmit module configured to transmit the data packet to the next node,
wherein said modules comprise hardware circuits, a programmable hardware device and/or program code stored on computer readable storage media.

24. The apparatus of claim 23, further comprising a tunneling header module configured to add the tunneling protocol header to the data packet header of the data packet in response to the received data packet lacking a tunneling protocol header.

25. The apparatus of claim 23, wherein the segment routing header comprises a length field comprising a value indicating a length of the segment routing header and/or a next type field comprising a value indicating a protocol of a payload of the data packet, the next type field comprising a field indicating a type of a header and/or data following the tunneling protocol header.

26. The apparatus of claim 23, wherein the list of nodes in the data pathway are arranged in an order of travel of the data packet to the egress node and wherein a pointer value of zero corresponds to the egress node.
